(19) United States
(12) Patent Application Publication
(10) Pub. No.: US 2003/0163731 A1
(43) Pub. Date: Aug. 28, 2003

(54) Method, system and software product for restricting access to network accessible digital information

(76) Inventors: David Wigley, Reid (AU); Mark Riley, Campbell (AU); Peter Wigley, Reid (AU)

Correspondence Address: DAVID B. RITCHIE, THELEN REID & PRIEST LLP, P.O. BOX 640640, SAN JOSE, CA, 95164-0640, US

(21) Appl. No.: 10/086,287

(22) Filed: Feb. 28, 2002

(51) Int. Cl. H04L 9/00

(52) U.S. Cl. 713/201; 713/182

(57) ABSTRACT

A method for restricting access to network accessible digital information by network users of at least one subscriber network. The method comprises the steps of monitoring at each subscriber network all requests by the network users for digital information; determining whether a location indicator associated with each request is included in a database of restricted location indicators maintained at each subscriber network and denying the request where the location indicator is in the database. The method also involves retrieving the digital information stored at the location indicator and analyzing the content of the information for a predetermined maximum time in the event that the location indicator is not in the database and denying or fulfilling the request based on the content analysis, periodically forwarding the location indicators not in the database from the subscriber networks to a remote network node; retrieving the digital information stored at the forwarded location indicators at the remote network node and analyzing the content of the information; and periodically forwarding the location indicators found to have restricted content from the remote network node to the subscriber networks for inclusion in the database of restricted location indicators,

### FIELD OF THE INVENTION

The invention relates to computer networks and digital information available on those networks. The invention relates to methods by which access to certain digital information available on a computer network may be restricted.

### BACKGROUND OF THE INVENTION

Since the earliest days of computing the desirability of connecting computers in a network has been recognized. Computer networks allow files and programs to be shared, thereby reducing duplication and expanding the range of available material. It has become increasingly common for individual computers and networks such as those maintained by businesses, schools and public institutions to be connected to public wide area networks, such as the Internet. Connection to the Internet allows communication and sharing of information on a global basis. Allied with the ability to digitize a wide range of content, including images, sound and video there is now an almost incalculable amount of content available via computer networks. This ubiquitous connection of computers to vast networks has however brought with it certain undesirable consequences.

Generally, content available on the Internet is not regulated by any central authority, with a computer or network needing only to conform to technical protocols to connect to the network. The large memory capacity of modem computers also makes it difficult for a network administrator to have knowledge of what type of content is actually stored on the computers on the network.

Accordingly certain content such as pornography, racist and violent materials are freely available to users on the Internet. With the free availability of this type of content has come the call for increased measures to protect particularly children from exposure to such materials. Similarly, many corporate computer networks are also now connected to the Internet. Connection to the Internet by corporate users allows worldwide communication via e-mail access to work related resources and the ability to remotely access the corporate network resources. However, certain types of content available on the Internet are more leisure type activities such as home shopping or music download. Employers who provide employees with Internet access are becoming increasingly aware of the need to restrict employee access to such materials during working hours.

To answer some of these needs a number of different systems have been proposed. Firstly, there are rating systems where content is voluntarily classified. One such system developed by the W3 organization, called the Platform for Internet Content Selection (PICS), directly embeds the rating of a particular web page into the HTML code for the page. Certain settings on software used to access web pages (called browsers) is set so that requests for web pages with a particular rating will not be fulfilled. It should be noted however, that PICS is a purely voluntary system.

An alternative approach to the access restriction problem has been the development of filtering software. One approach adopted by software filters is to build up and distribute a database of location indicators of sites at which restricted content is stored. In this way, when a user requests an address included in the database, access to the content is denied. This approach is generally termed the “Black List” approach as opposed to the “White List” approach where a database of the addresses of permitted content is maintained. The growth and rate of change of both the hardware and content of computer networks can not be measured with any real accuracy. Both the hardware, and the content stored is constantly added and removed from various computer networks including the Internet on at least a daily basis. Flexible addressing means by which particular content available for example, on the Internet, is accessed also enables content to be taken from one “location” and moved to another “location” almost instantly. The end result for filtering systems based on a database of restricted location indicators is that the database itself quickly becomes out of date, with countless other location indicators storing or providing access to restricted content existing, yet not appearing in the database.

Currently the databases are compiled by the vendors filtering software with the now location indicators being discovered by employees paid to surf the Internet or by computer software agents guided by particular algorithms. Both of these approaches have been found to be somewhat unsatisfactory. Using human agents is both time consuming and expensive for the software vendors. The algorithms by which software agents discover new location indicators are still in their infancy and are prone to “going down blind alleys” and “hitting dead ends”. The need for an improved solution for filtering software, particularly for use in schools, public libraries and corporations remains strong. Accordingly an improved method for restricting access to network accessible digital information is required.

### OBJECTS OF THE INVENTION

An object of the present invention is to provide an improved method of restricting access to network accessible digital information and in particular to information available via the Internet. It is a further object of the present invention to provide a database of restricted location indicators, (or “addresses”) for use with Internet filtering software which is more accurate and up to date than current databases.

It is yet a further object of the present invention to provide a filtering software product which is independent of any proxy server software or other network device present on a particular network and which need not be updated each time there is an update of the proxy server software. It is yet another further object of the present invention to provide an adaptable filtering process which is configurable to suit the individual circumstances and acceptable use policies of particular networks.

### SUMMARY OF THE INVENTION

According to a first aspect of the present invention, there is provided a method for restricting access to network accessible digital information by network users of at least one subscriber network, said method comprising the steps of:

(a) monitoring at each subscriber network all requests by the network users for digital information;

(b) determining whether a location indicator associated with each request is included in a database of restricted location indicators maintained at each subscriber network and denying the request where the location indicator is in the database;

(c) retrieving the digital information stored at the location indicator and initially analyzing the content of the information for a predetermined maximum time in the event that the location indicator is not in the database and denying or fulfilling the request based on the initial analysis;

(d) periodically forwarding the location indicators not in the database from the subscriber networks to a remote network node;

(e) retrieving the digital information stored at the forwarded location indicators at the remote network node and analyzing the content of the information; and

(f) periodically forwarding the location indicators found to have restricted content from the remote network node to the subscriber networks for inclusion in the database of restricted location indicators.

According to a second aspect of the present invention there is provided a system for restricting access to network accessible digital information by network users of at least one subscriber network, said system comprising:

(a) a database of restricted location indicators stored at each subscriber network;

(b) monitoring means at each subscriber network for monitoring all requests by the network users of the subscriber network for digital information;

(c) said monitoring means also determining whether a location indicator associated with each request is in the database;

(d) analysis means at each subscriber network for initially analyzing the content of the information stored at each location indicator not in the database for a predetermined maximum time and for denying or fulfilling the request based on the initial analysis;

(a) forwarding means at each subscriber network for periodically forwarding the location indicators not in the database to a remote network node;

(f) retrieval and analysis means at the remote network node for retrieving the digital information stored at each of the location indicators forwarded by the subscriber networks and further analyzing the content of the information; and

(g) dispatching means at the remote network node for periodically dispatching the location indicators found to have restricted content by the retrieval and analysis means to the subscriber networks for inclusion in each database.

According to a third aspect of the present invention there is provided a computer software product for restricting access to network accessible digital information by the network users of a subscriber network, said product comprising:

(a) computer readable program code means for monitoring all requests by the network users for digital information;

(b) computer readable program code means for determining whether a location indicator associated with each request is included in a database of restricted location indicators stored at the subscriber network;

(c) computer readable program code means for analyzing the content of the information stored at each location indicator not in the database for a predetermined maximum time and for denying or fulfilling the request based on the analysis;

(d) computer readable program code means for periodically forwarding the location indicators not in the database to a remote network node; and

(e) computer readable program code means for periodically receiving location indicators from the remote network node and including said location indicators in the database.

The present invention provides a method, system and software product for restricting access to network accessible digital information. The present invention uses a database of restricted location indicators which is continually updated and refined. Unlike present approaches of compiling such databases, the present invention discovers new location indicators through the everyday use of computer networks by network users. In this specification, the term “subscriber network” is intended to be construed broadly and includes a unitary digital device and a network of such digital devices. The term “subscriber” is also not to be construed as requiring payment for use of the service.

In a broad sense, the present invention employs a collaborative filtering process whereby location indicators, such as a Uniform Resource Locators, not in the database of restricted sites, discovered by network users through their use of the computer network, are periodically uploaded to a remote network node (or “data center”) whereupon they are processed and periodically downloaded to the databases stored at each subscriber network. The constantly updated database is used to restrict the access to particular digital information.

### BRIEF DETAILS OF THE DRAWINGS

To assist the understanding the invention preferred embodiments will now be described with continued reference to the following figures in which:

FIG I is a flowchart illustrating the high level collaborative filtering process;

FIG. 1A is an illustration of the network environment of subscriber networks, a wide area network and remote network nodes;

FIG. 2 is an illustration of a first subscriber network topology;

FIG. 3 is an illustration of a second subscriber network topology;

FIG. 4 is an illustration of a third subscriber network topology;

FIG. 6 is an illustration of a fourth subscriber network topology;

FIG. 6 is a flowchart detailing the filtering process at a subscriber network; and

FIG. 7 is a flowchart detailing the use of exception lists and characterization fields.

### DESCRIPTION OF PREFERRED EMBODIMENTS

Preferred embodiments of the present invention will now be described with continued reference to the drawings, wherein the embodiments are described by reference to requests for digital information available on the Internet. The invention however is equally applicable to locally stored information available on a LAN or on a single digital device.

1A illustrates a plurality of digital devices 200, such as personal computers connected to the Internet 201. Additionally, the devices are connected into separate subscriber networks 112A-112D. Each of the subscriber networks 112A-112D includes a database 114A-114D that stores restricted location indicators at which restricted digital information is available as occurs in the prior art. There are of course many other local networks connected to the Internet that may not utilize the present invention and accordingly are not subscriber networks.

Also connected to the Internet is a remote network node 118. As will be further described below, this remote network node 118 periodically receives location indicators from the subscriber networks 112A-112D, processes the digital information available at those location indicators, and periodically uploads lists of location indicators to the subscriber networks 112A-112D for inclusion in the database 114A-114D.

As will also be further described below, the location indicators uploaded from the subscriber networks 112A-112D are discovered by network users 120A-120D of the subscriber networks through their everyday retrieval of information from the Internet.

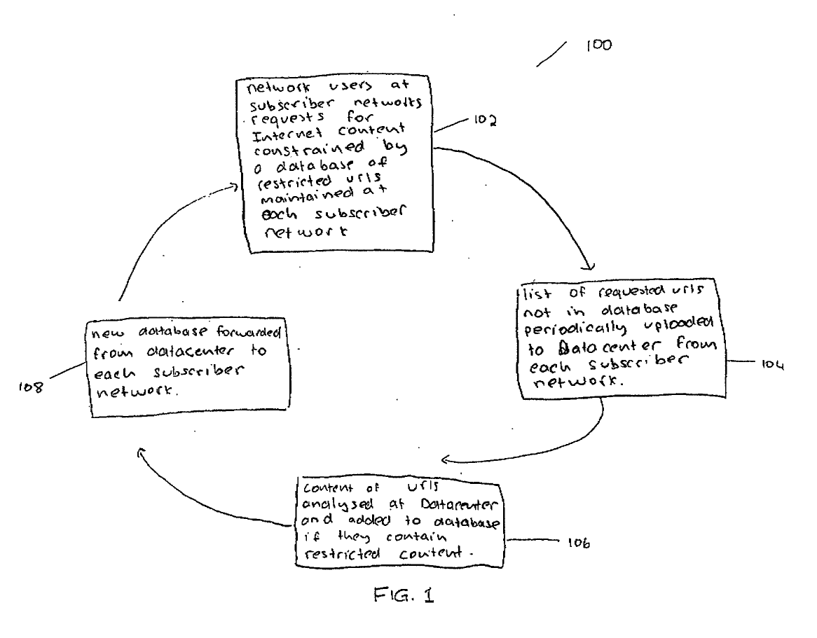

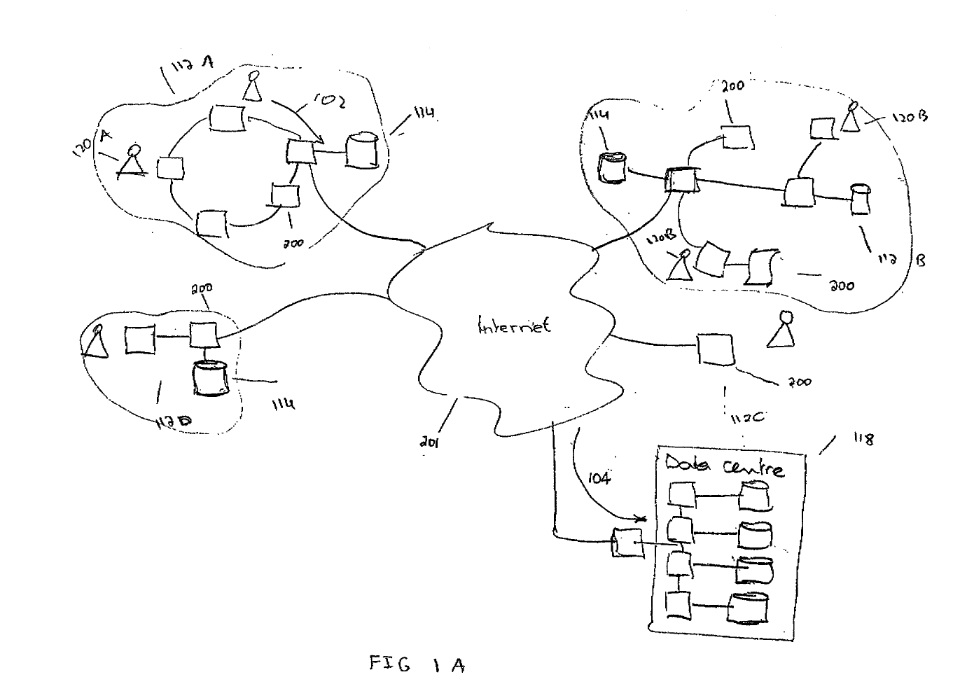

FIG. 1 illustrates the high level functional aspects of the collaborative content filtering system 100. In one aspect 102 network users at the subscriber networks make requests for digital information such as a plurality of web pages available on the Internet. The requests are filtered against a database maintained locally at each subscriber network or terminal device. The lower level implementation of these requests is described in more detail below with reference to FIG. 6.

In the case of a request for a web page, the web page is identified by a location indicator such as a Uniform Resource Locator (URL). A URL generally takes the format of:

http://host/file.html;

wherein the “http” portion specifies the protocol by which the requested web page is retrieved. The usual protocol to retrieve web pages is the hypertext transfer protocol. The “host” portion specifies the name of the computer (or server) on which the web page is stored. The “file” component is the file name for the web page.

Those requests for content are constrained by the database of URL's which is also stored at each subscriber network. If the URL of a web page requested by a network user is included in the database, access to that web page will be denied to the network user in certain circumstances. The URL's stored in the database may restrict access to all the files stored at a particular server, or alternatively to only selected-files.

In the second aspect 104 of the system, a list of URLs requested by network users is periodically uploaded from each subscriber network to a remote network node accessible from the subscriber network. The URLs are those requested by network users during a predetermined period, through everyday use of the Internet. The URL's can be requested, for example by keying them directly into a web browser or by following a link to another site from a web page already retrieved by the browser. Each subscriber network uploads their respective list of URLs to the remote network node. The data is uploaded via any convenient protocol, such as http 106. In a preferred embodiment each subscriber network uploads data on an hourly basis.

The plurality of URL lists are received at the remote network node. Software at the remote network node retrieves the web pages stored at the various URLs and subjects them to content analysis algorithms. The operation of those algorithms is discussed in further detail below.

Broadly, the content analysis algorithm examines the text of each web page and determines the existence and frequency of certain key words and phrases. Based on that analysis the web page is assigned one or more categories, such as sex or violence. Database updates are then prepared at the data center which are new database records including the fields of the URL and the category assigned to that URL by the content analysis algorithm. In some cases the web page may be subject to further analysis by way of human review where the content analysis algorithm is unable to assign a category to the web page 108 within a specific time. The new database records are forwarded from the remote network node to each of the subscriber networks for inclusion in the database of URLs stored at the subscriber network. Again, this occurs on a periodic basis, and in a preferred embodiment a subscriber network would expect to have its database of restricted URLs updated hourly. The download of data may be implemented by any suitable protocol such as (preferably) http or ftp.

The process then begins again with the network users requests for digital information being constrained by the amended database 102.

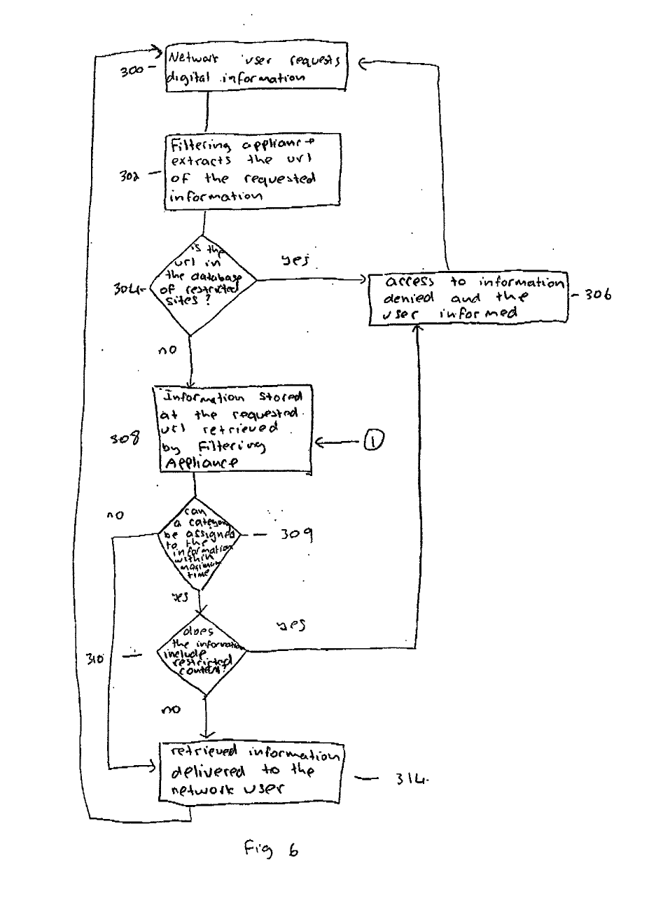

FIGS. 2 to 5 detail alternative network topologies which may be found at various subscriber networks and how the filtering apparatus of the present invention may be incorporated into those networks. In each of FIGS. 2 to 5 there are a plurality of digital devices 200 upon each of which a network user (not shown) is engaged. The digital devices in this case are IBM compatible type personal computers running Microsoft's Windows™ operating system, however the invention is applicable to any digital device that may be connected to a network such as an Apple Macintosh™ type computer or a computer utilizing the UNIX or LINUX operating system such as those manufactured by Sun Microsystems. The invention is equally applicable to other digital devices such as mobile phones or personal digital assistants. Each of the computers (200) are connected to form a subscriber network. In this embodiment the subscriber networks are local area networks. A local area network is a network that spans a limited area such as a single floor, building or campus.

The computers 200 each include a Network Interface Card (NIC) (not illustrated) enabling it to communicate with other computers on the local area network. The NICS operate with a driver program running on the computer. The driver allows application programs such as web browsers, running on the computer to send and receive data from the local area network. A driver commonly provided with the Windows operating system is Winsock. In each of the topologies illustrated in FIGS. 2 to 5 the local area network implements communication via the Ethernet protocol running over a cable 216. Again the present invention may utilize other network protocols and physical connection means such as a wireless LAN.

In each case the client computers connect to the network via an Etherswitch 25 208 which acts to send and receive Ethernet frames to and from the various computers connected to the Etherswitch 208, as is well known in the prior art. A frame is the basic unit of data transmitted between computers on the same Ethernet. The frame contains a header consisting of control and addressing information, data and a trailer. The data may include headers and trailers inserted by higher level protocols. The local area networks of each topology of FIGS. 2 to 5 are connected to the global Internet 201. The connection is usually by way of a router or gateway (not shown) which connects the local area network to a node on a wide area network (WAN).

It is this constant linking of networks which eventually forms the global Internet 201.

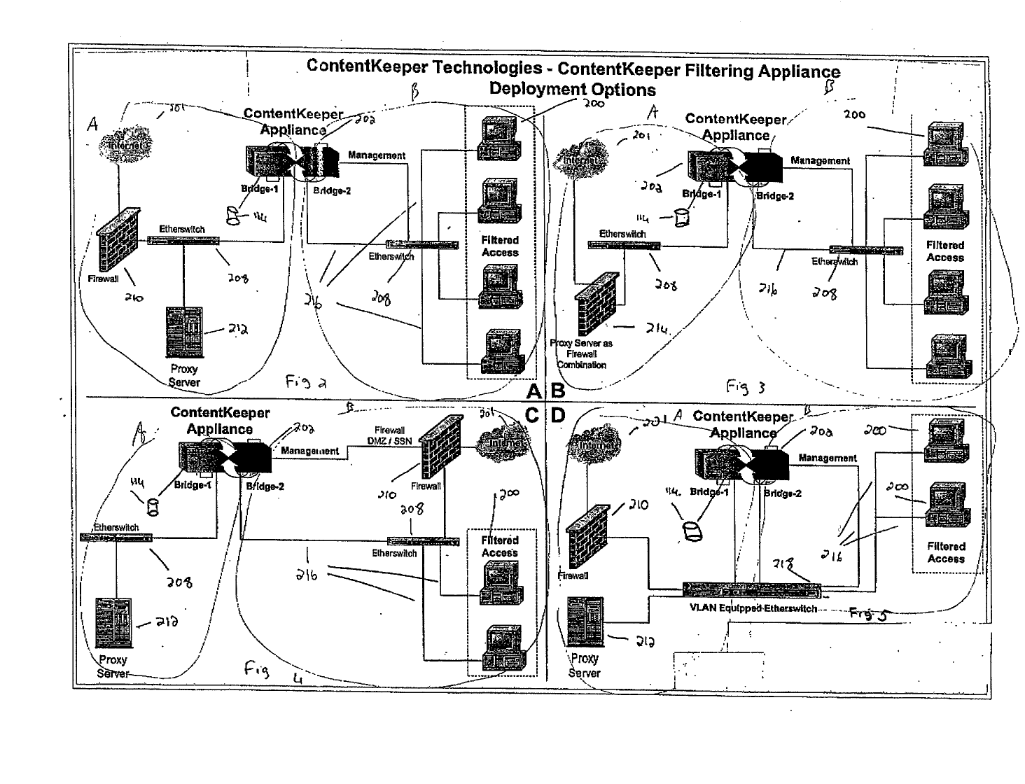

The subscriber network may connect to the Internet via a firewall 210 which is a software and hardware system designed to protect the resources of a local area network from unauthorized use through the Internet 201. The local area network may also include a proxy server 212 which is a server that acts as an intermediary between a client computer 200 and the Internet 201. In some cases the proxy server and firewall can be combined in a single server 214 as illustrated in FIG. 3.

The proxy server receives a request for an Internet service such as a web page from one of the client computers 200. The proxy server then retrieves the web page from the Internet and returns it to the client computer 200. In some cases proxy servers implement cache facilities by storing web pages to speed up the retrieval of frequently requested web pages rather than repeatedly retrieving them from the Internet 201. The proxy server may use one of its own IP addresses to request a web page from the Internet rather than using an IP address from one of the client computers 200.

The local area networks illustrated in FIGS. 2 to 5 also include an Ethernet bridge 202 which has the effect of breaking the local area network into two sub-networks A and B. The role of the bridge 202 in each case is to route Ethernet frames from the sub-network B containing the client computers 200 to the sub-network A containing the proxy server 212, 214.

The Ethernet bridge has access to a database of restricted URLs 114. In a preferred embodiment the database is stored in an encrypted form, for additional security- Also stored on the Ethernet bridge 204 are instructions which implement the content analysis algorithms. The use of the database and the content analysis algorithms will be examined in greater detail below.

Turning to FIG. 6 the lower level filtering process of the present invention is illustrated. At step 300 a network user 120 at one of the client computers 200 requests digital information from the Internet 201. In the case of a web page the request is made via an Internet browser such as Netscape™ or Microsoft's Internet Explorer™ running on the client computer 200. Typically the network user keys in a URL in the form noted above into the browser or clicks a link to an Internet site from another web page. The browser retrieves the URL and forms a hypertext transfer protocol (http) GET request which includes the URL. The GET request is forwarded through the driver software for the NIC. The driver software takes the http request and forms an Ethernet frame which can be delivered by the NIC via the network cable 216 and through the Etherswitch 208. Each node on an Ethernet is aware of every Ethernet frame that has been placed onto the network cable 216. The Ethernet bridge 202 can accordingly sense each of the frames and by examining the contents determine if they are http GET requests.

At step 302 software running on the Ethernet bridge 202 extracts the URL from the Ethernet frame. A search of the data base 114 accessible to the Ethernet bridge is made to determine whether the URL is a restricted site 304. In a preferred embodiment, the URL is first encrypted by the software and the search of the database is made for the encrypted URL.

In the event the URL is a location indicator to restricted site, access to the information stored at the URL is denied to the network user 120 and that network user is informed of the denial by message on the browser. The network user 120 is then free to use the client computer for other purposes, including requesting Internet content 300.

In the event the URL is not a location indicator to restricted site the bridge 202 passes the frame to sub-net A which contains the proxy server 212. The proxy server retrieves the web page from the Internet and stores a local copy on the Ethernet bridge 202. Content analysis software also running on the bridge 202 then determines whether the site contains restricted content. A time limit 309 in which the software must analyze the content is set to ensure that real time filtering can occur. In the event that the site can not be assigned a category by the algorithm within the time limit, the information will be delivered to the network user 314. The content analysis algorithm operates by scanning the text for search strings and search phrases. Different categories of content can be detected by applying applicable search criteria. A profile of a particular category of content can be built up from the results of prior searches. The profiles are built up using neural networks and learning algorithms.

Examples of these algorithms and techniques are given in Baeza-Yates, Ricardo and Berthier Ribeiro-Neto., Modem Information Retrieval Harlow, England 1999 Addison-Wesley & Franks 1999, and William B. and, Ricardo Baeza-Yates. Information Retrieval., Data Structures and Algorithms. Englewood Cliffs, N.J. Prentice Hall 1992, the contents of which are incorporated herein by reference. In the event that the web site does include restricted content access to the information is denied 306 and the network user 110 at client computer 200 is informed. A copy of the URL is retained on the Ethernet bridge 202 for later upload to the remote network node 118 for inclusion in the database existing at each of the subscriber networks. A copy of the URL will also be retained where the content filtering software has been unable to analyze and classify the content within the specified time. Where the web site does not include restricted content the web page 314 is delivered through the Ethernet bridge 216 back to the client computer 200.

Preferred embodiments of the present invention contain customization features allowing different levels of filtering to occur at the Ethernet bridge 202 depending on the policies adopted at a particular subscriber network 112. These features can be customized by a privileged user who can access the software either through the Ethernet bridge 202 directly or via a client computer 200 on the same LAN. Access to the customization features may be password protected.

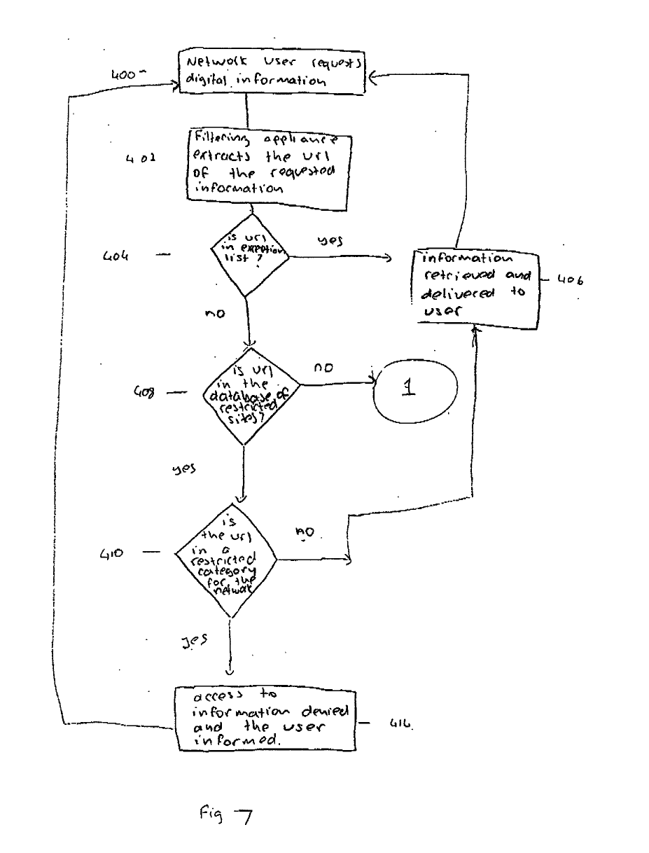

Turning to FIG. 7, at step 400 network users request information in a similar way as described above. At step 402 the filtering software extracts the URL from the Ethernet frame delivered by the client computer 200. At step 404 the filtering software searches an exception list for the URL. In the event that the URL is in the exception list the web page will be retrieved from the Internet and delivered to the user at step 406. In this way a particular subscriber network may have access to web sites that may be contained in the restricted site database. The process employs a combination of white list and black list filtering. The exception list is thus used to bypass the filtering process and the restricted URL database. It can also be used to build up a list of frequently visited sites which are allowable and thereby reduce usage of system resources in retrieving and analyzing the same sites. At step 408 in the event that the URL is not in the exception list the database of restricted sites is searched for the URL. In the event that the URL is not in the restricted sites the usual process occurring from step 308 of FIG. 6 continues.

In the event that the URL is in the database of restricted sites, the software then examines the categories field of the database entry of the URL. Additional customization features may allow the filtering software to deny access to certain types of sites such as pornography whilst allowing access to other types of sites such as music downloads or home shopping for instance. On another subscriber network both pornography and music downloads may be prohibited. Accordingly, although a site may be listed in the restricted URL database it may be in a category that is allowed at the particular subscriber network. If this is the case, at step 412, the information is retrieved from the Internet and delivered back to the client computer 200. In the event that it is in a restricted category, access to the information is denied and the user is informed at step 414.

The collaborative content filtering system thus provides a constantly expanding and refined database. The database itself is being updated with the “live” URLs which are being discovered by the network users across the possibly thousands of subscriber networks through their everyday use of the Internet. This aspect will ameliorate some of the deficiencies found in prior art filtering systems using bots or a limited number of humans to search the Internet.

Additionally, preferred embodiments of the present invention are independent of the particular software running on a proxy server. This is achieved by having the filtering occur at the datalink layer, rather than the application layer.

The present invention, in preferred forms also provides additional security by storing the database of restricted sites in encrypted form at the subscriber networks.

Additionally, the customization features of the present invention allow each subscribed network to implement the filtering process in accordance with the acceptable use policies existing at that network.

It is understood that various other modifications Will be apparent to and can be readily made by those skilled in the art without departing form the scope and spirit of the present invention. For instance, the Ethernet bridge 202 may be used to extract materials available via news groups or FTP sites rather than just web sites. The software may also be used to subject the content of e-mail to the restricted site database. The particular hardware, software and network topology used to implement the features of the present invention is also not intended to be limiting.

Accordingly, it is not intended that the scope of the claims be limited to the description or the illustrations set forth herein, but rather that the claims be construed as encompassing all features of patentable novelty that reside in the present invention, including all features that would be treated as equivalent by those skilled in the art.

We claim:

1. A method for restricting access to network accessible digital information by network users of at least one subscriber network, said method comprising the steps of:
(a) monitoring at each subscriber network all requests by the network users for digital information;
(b) determining whether a location indicator associated with each request is included in a database of restricted location indicators maintained at each subscriber network and denying the request where the location indicator is in the database;
(c) retrieving the digital information stored at the location indicator and initially analyzing the content of the information for a predetermined maximum time in the event that the location indicator is not in the database and denying or fulfilling the request based on the initial analysis;
(d) periodically forwarding the location indicators not in the database from the subscriber networks to a remote network node;
(e) retrieving the digital information stored at the forwarded location indicators at the remote network node and further analyzing the content of the information; and
periodically forwarding the location indicators found to have restricted content from the remote network node to the subscriber networks for inclusion in the database of restricted location indicators.

2. The method of claim 1 wherein the digital information includes content accessible via the Internet.

3. The method of claim I wherein the subscriber networks are local area networks wherein client computers communicate via the Ethernet access protocol.

4. The method of claim 3 wherein the searching of the database and the initial content analysis occur at an Ethernet bridge installed at the subscriber network.

5. The method of claim I wherein the location indicator is a Uniform Resource Locator.

6. The method of claim 4 wherein the location indicator is extracted from an Ethernet frame originating from a client computer of a network user.

7. The method of claim 1 wherein the database is stored in encrypted form and is searched for an encrypted location indicator.

8. The method of claim I including the step of determining whether the location indicator is in an exception list before determining whether it is in the database and fulfilling the request in the event that the location indicator is in the exception list.

9. The method of claim 1 wherein the request is fulfilled in the event that the location indicator is in the database but is a permitted category of restricted content.

10. The method of claim 1 wherein the location indicators are forwarded from the subscriber networks to the remote network node on at least an hourly basis and the location indicators are forwarded from the remote network node to the subscriber networks on at least an hourly basis.

11. A system for restricting access to a network accessible digital information by network users of at least one subscriber network, said system comprising:
(a) a database of restricted location indicators stored at each subscriber network;
(b) monitoring means at each subscriber network for monitoring all requests by the network users of the subscriber network for digital information;
(c) said monitoring means also determining whether a location indicator associated with each request is in the database;
(d) analysis means at each subscriber network for initially analyzing the content of the information stored at each location indicator not in the database and for denying or fulfilling the request based on the initial analysis;
(e) forwarding means at each subscriber network for periodically forwarding the location indicators not in the database to a remote network node;
(f) retrieval and analysis means at the remote network node for retrieving the digital information stored at each of the location indicators forwarded by the subscriber networks and further analyzing the content of the information; and
(g) dispatching means at the remote network node for periodically dispatching the location indicators found to have restricted content by the analysis means to the subscriber networks for inclusion in each database.

12. The system of claim 11 wherein the digital information includes content accessible via the Internet.

13. The system of claim 11 wherein the subscriber networks are local area networks communicating via the Ethernet protocol.

14. The system of claim 13 wherein the monitoring means are installed at an Ethernet bridge installed at the subscriber network.

15. The system of claim 11 wherein the location indicator is a Uniform Resource Locator.

16. The system of claim 14 wherein the location indicator is extracted from an Ethernet Frame originating from a client computer of a network user.

17. The system of claim 11 wherein the database is stored in encrypted form and is searched by the monitoring means for an encrypted location indicator.

18. The system of claim 11 wherein the monitoring means determine whether the location indicator is in the exception list before determining whether it is in the database and fulfils the request in the event that the location indicator is in the exception list.

19. The system of claim 11 wherein the system fulfils requests in the event that the location indicator associated with the request is in the database, but is a permitted category of restricted content.

20. The system of claim 11 wherein the forwarding means and the dispatching means deliver location indicators on an hourly basis.

21. A computer software product for restricting access to network accessible digital information by the network users of a subscriber network, said product comprising:
(a) computer readable program code means for monitoring all requests by the network users for digital information;
(b) computer readable program code means for determining whether a location indicator associated with each request is included in a database of restricted location indicators stored at the subscriber network;
(c) computer readable program code means for analyzing the content of the information stored at each location indicator not in the database and for denying or fulfilling the request based on the analysis;
(d) computer readable program code means for periodically forwarding the location indicators not in the database to a remote network node; and
(e) computer readable program code means for periodically receiving location indicators from the remote network node and including said location indicators in the database.

22. The computer software product of claim 21 wherein the digital information is content accessible via the Internet.

23. The computer software product of claim 22 wherein the subscriber network is a local area network wherein client computers communicate via the Ethernet protocol.

24. The computer software package product of claim 22 wherein the location indicator is a Uniform Resource Locator.

25. The computer software product of claim 23 wherein the location indicator is extracted from an Ethernet frame originating from a client computer of a network user.

26. The computer software product of claim 21 further comprising computer readable code means for encrypting the location indicator before including in the database or determining whether the encrypted location indicator is in the database.

27. The computer software product of claim 21 further comprising computer readable code means for determining whether the location indicator is in an exception list before determining whether it is in the database and for fulfilling the request in the event that the location indicator is in the exception list.

28. The computer software product of claim 21 further comprising computer readable program code means for fulfilling a request in the event that the location indicator is in the database but is a permitted category of restricted content.

29. The computer software product of claim 21 wherein the location indicators are forward to, and received from, the remote node on at least an hourly basis.
